(19) United States
(12) Patent Application Publication
(10) Pub. No.: US 2026/0187237 A1
(43) Pub. Date: Jul. 2, 2026

(54) SYSTEM AND METHOD FOR ANALYZING COMPUTER EVENTS

(71) Applicant: NUCLEON-SECURITY, PARIS (FR)

(72) Inventor: Antoine BOTTE, LE MESNIL LE ROI (FR)

(73) Assignee: NUCLEON-SECURITY, PARIS (FR)

(21) Appl. No.: 19/414,536

(22) Filed: Dec. 10, 2025

(30) Foreign Application Priority Data
Dec. 10, 2024 (FR) 2413764

(51) Int. Cl. G06F 21/55; G06F 16/2457; G06F 18/22

(52) U.S. Cl. CPC G06F 21/554; G06F 16/2457; G06F 18/22

(57) ABSTRACT

The present invention concerns a method and a system configured for analyzing computer events in the context of cybersecurity. In particular, the present invention relates to collecting events, normalizing elements specific to these events and calculating an overall criticality score based on a similarity analysis with a database of reference events.

### TECHNICAL FIELD OF THE INVENTION

The present invention relates to the technical field of computer security systems, in particular, the technical field of on-demand security event analysis systems.

### PRIOR ART

In the technical field of detecting computer threats, also known as “cyber threats”, current approaches primarily rely on recognizing known signatures and malicious behavior. Predominant examples include YARA rules for identifying malware specimens, Sigma for detecting threats in event logs, for example, and the MITRE ATT&CK framework, which categorizes the tactics and techniques used by attackers, as well as Living Off the Land Binaries and Scripts (LOLBAS), which identifies the malicious use of legitimate tools.

These approaches are based on known malicious behavior. Distinguishing between normal activities and potentially malicious actions in new or ambiguous contexts remains a challenge.

Therefore, the present invention aims to improve the detection of cyber threats, at least in part.

Further objects, features and benefits of the present invention will become apparent on examination of the following description and accompanying drawings. It is understood that further benefits may also be included.

### SUMMARY

The present invention relates to a method for analyzing at least one computer event, said method being configured to be implemented by at least one computer system, said method comprising at least the following steps:
a. Receiving, by at least one communication module, at least one computer event, said computer event comprising a plurality of fields, each field of said plurality of fields comprising at least one data item;
b. Normalizing, by at least one data processing module, each data item of each field of said plurality of data items of said computer event;
c. Analyzing, by at least one analysis module, said normalized data with respect to reference data associated with reference computer events of a primary database, the analysis step comprising for each normalized item of data:
i. Identifying at least one reference computer event, this identification step comprising:
A) For each value of said normalized data item, searching for at least one reference event comprising at least one similar value in the primary database;
ii. If the reference computer event comprises, preferably exactly, the same fields with the same values, then the event is legitimate;
iii. If the reference computer event does not comprise, preferably exactly, the same fields with the same values, then:
A) Calculating a criticality score, with respect to said identified reference computer event, for the field or fields of said plurality of fields of said computer event whose values are different:
   Calculating the diversity between the values associated with said computer event and the values associated with said reference computer event; and
   Comparing this diversity with a first predetermined threshold value specific to each field so as to obtain a criticality score;
B) Calculating an overall criticality score for said computer event by summing together the calculated criticality scores;
C) Said overall criticality score is configured for use in decision-making by at least one operator.

The present invention also relates to a computer program product comprising a plurality of instructions which, when they are executed by at least one processor, execute the method according to the present invention.

The present invention also relates to a non-transitory memory medium comprising a computer program product according to the present invention.

The present invention also relates to a computer system for analyzing at least one computer event, said system comprising at least:
a. A communication module configured for:
i. Receiving at least one computer event, said computer event comprising a plurality of fields, each field of said plurality of fields comprising at least one data item;
b. A data processing module configured for:
i. Normalizing each data item of each field of said plurality of fields of said computer event;
c. An analysis module configured for:
i. Analyzing said normalized data with respect to reference data associated with reference computer events in a primary database;
ii. Identifying at least one reference computer event;
iii. Calculating a criticality score, with respect to said identified reference computer event, for the field or fields of said plurality of fields of said computer event whose values are different;
iv. Calculating the diversity between the values associated with said computer event and the values associated with said reference computer event;
v. Comparing this diversity with a first predetermined threshold value specific to each field so as to obtain a criticality score;
vi. Calculating the sum of the calculated criticality scores so as to calculate an overall criticality score.

### BRIEF DESCRIPTION OF THE FIGURES

The aims, object, features and benefits of the invention will become clearer from the detailed description of one embodiment thereof shown in the following accompanying drawings in which:

FIG. 1 schematically depicts a method according to one embodiment of the present invention.

FIG. 2 schematically depicts a system according to one embodiment of the present invention.

FIG. 3 depicts a diagram exemplifying several steps of a method according to one embodiment of the present invention.

FIG. 4 depicts another diagram exemplifying several other steps of a method according to one embodiment of the present invention.

The drawings are given by way of example and are not restrictive of the invention. They are schematic depictions of principles intended to facilitate the understanding of the invention and are not necessarily on the scale of the practical applications. In particular, the dimensions are not representative of reality.

### DETAILED DESCRIPTION

Before undertaking a detailed review of the embodiments of the invention, some optional features that can optionally be used in combination or alternatively are recited below:

According to one example, the computer event comprises at least two components: a component initiating at least one action, and an action component configured to perform at least one action.

According to one example, the step of searching for similar values comprises searching for a maximum of matching fields between the computer event and the reference computer event.

According to one example, calculating the diversity of values involves calculating a variance.

According to one example, the predetermined threshold value is a variance.

According to one example, the present invention comprises a decision-making step based on at least one criticality score and/or said overall criticality score.

According to one example, said decision may comprise issuing a notification, and/or executing a predetermined computer security protocol.

According to one example, the present invention comprises an analysis step based on at least one criticality score and/or said overall criticality score.

According to one example, the present invention comprises a step of calculating a criticality pre-score comprising:
a. Vectorizing reference computer events so as to generate a plurality of reference vectors;
b. Vectorizing the computer event so as to generate an event vector;
c. Calculating a distance between the event vector and each reference vector of said plurality of reference vectors;
d. Selecting the smallest of the calculated distances, this selected distance corresponding to said criticality pre-score.

According to one example, the diversity calculation is carried out by vectorization.

According to one example, the present invention comprises at least one step of building said primary database of reference computer events, the building step comprising at least:
a. Receiving a plurality of computer events comprising a set of fields;
b. If all the fields contain identical values:
i. Deduplicating, by said data processing module, each event of said plurality of computer events;
ii. Evaluating, by at least one event module, the number of times the event has occurred;
c. Normalizing, by said data processing module, each data item of each computer event of said plurality of computer events;
d. For each event of said plurality of computing events:
i. Searching in said primary database if the computer event exists:
A) If the computer event exists in said primary database: modifying the frequency information of said computer event to add a new occurrence of said computer event, said frequency information comprising at least an entity number having reported said computer event, an occurrence number of said computer event, for example per day, per month, and/or per year;
B) Otherwise: Searching a secondary database:
   If the computer event exists in said secondary database:
   Modifying the frequency information of the computer event, preferably with the recording of the new date on which the computer event has just occurred;
   If at least one of the modified frequency information values is above a predetermined threshold, moving said computer event to the primary database;
   Otherwise, adding the event to the secondary database

According to one example, the present invention comprises a local learning phase for adapting the primary database to a specific perimeter, said phase comprising:
a. Collecting local computer events on said specific perimeter;
b. Enriching the primary database with said local computer events satisfying at least one predetermined frequency criterion;
c. Preferably, generating a differential report between the primary database before and after said enrichment; and
d. Validating the added computer events before their final integration into the primary database.

According to one example, the present invention comprises at least one step of generating a report for each computer event comprising:
a. Said computer event with its fields, data, and values;
b. Said overall criticality score;
c. Preferably, at least one criticality score of at least one field of the plurality of fields;
d. The reference computer events whose overall criticality score is below a second threshold value.

According to one example, the operator is a human user or a machine, preferably comprising a decision-making unit.

The examples and the conditional language used in this description are mainly intended to help the reader understand the principles of the present invention and not to limit the scope thereof to such specifically cited examples and conditions. It is understood that a person skilled in the art may conceive of various arrangements which, although not explicitly disclosed or depicted herein, nevertheless embody the principles of the present invention and are included within its spirit and its scope.

In addition, to aid understanding, the following disclosure may describe relatively simplified implementations of the present invention. As a person skilled in the art will understand, various implementations of the present technology may be of greater complexity.

Furthermore, the following description listing the principles, aspects, and implementations of the present invention, as well as specific examples thereof, is intended to encompass both their structural and functional equivalents, whether currently known or to be developed in the future. Thus, for example, a person skilled in the art will appreciate that all the functional diagrams depicted herein represent conceptual views of illustrative circuits incorporating the principles of the present invention. Similarly, it will be understood that all the flowcharts and the like represent various processes that can be substantially represented on computer-readable media and thus executed by a computer or processor, whether or not that computer or processor is explicitly represented.

The functions of the various elements depicted in the figures, including any functional block referred to as a “processor” or “module”, may be performed using dedicated hardware or hardware capable of executing software in conjunction with a computer program or appropriate instructions. When they are provided by a processor, the instructions can be provided by a single dedicated processor, by a single shared processor, or by a plurality of individual processors, some of which may be shared. In certain embodiments of the present invention, the processor may be a general-purpose processor, such as a central processing unit (CPU), for example. Furthermore, the explicit use of the term “processor” should not be interpreted as referring exclusively to hardware capable of executing software and may implicitly include, but is not limited to, an application-specific integrated circuit (ASIC), a field-programmable gate array (FPGA), read-only memory (ROM) for storing software, random access memory (RAM), and non-volatile storage. Other materials, conventional and/or customized, can also be included.

The software modules, or simply the modules that are presumed to be software, can be represented here as any combination of flowchart elements or other elements indicating the execution of process steps and/or a text description. Such modules can be executed by hardware that is expressly or implicitly represented. Furthermore, it should be understood that the module may include, for example, but is not limited to, computer program logic, computer program instructions, software, firmware, hardware circuits, or a combination thereof that provides the required capabilities.

In the context of the present invention, an “event” or “computer event” refers to an action or set of actions occurring within a computer system. More precisely, a computer event can comprise two distinct parts:
a. A part initiating at least one action: This part can be characterized by the fact that it manages at least one action, through a program that executes this action.
b. An action part: This part can be characterized by the action performed by the program, as well as by the target of this action.

In the context of the present invention, “behavior” can be defined as actions or events occurring within a computer system. For example, the opening of a document named “Bonjour. word. docx” by a user named Charles Xavier is generally not considered important for analysis. However, processing and normalizing these data requires considerable effort to ensure that they comply with a norm, and to establish criteria for evaluating events with respect to generic norms.

In the context of the present invention, “Counting tables” refers to a table or tables configured to count computer events on a daily, monthly and annual basis for each type of computer event. Advantageously, these tables allow for statistical monitoring of the occurrence of events.

In the context of the present invention, “Data tables” refers to one or more specific tables configured to store detailed information about files, users, paths, etc. Preferably with all possible different values identified after normalization, as described below.

According to one embodiment, the present invention offers an on-demand analysis service for security events, especially via systems of the Endpoint Detection and Response EDR or Security Information and Event Management SIEM type.

In particular, an SIEM system is configured for security management by combining security information management (SIM) and security event management (SEM). The SIEM collects and analyzes security data from various sources (such as event logs, security alerts, etc.) to provide an overview of the security of the organization. It allows security incidents to be detected and analyzed, and potential threats to be quickly addressed.

According to one embodiment, the present invention advantageously implements an advanced normalizing and contextualizing methodology to transform heterogeneous data from multiple sources into a unified format, enabling consistent and comparative analysis. Preferably, the system evaluates events by assigning a risk score, based on their deviation from normative patterns established in a database. This versatile and adaptable approach makes the present invention particularly relevant in a cybersecurity landscape where threats are diverse, constantly evolving and where there is a need to be able to quickly assess technical information.

According to one embodiment, the present invention represents a revolutionary approach to cybersecurity by focusing on the detection of abnormal behavior based on a comprehensive data set of known normal behavior. This invention, which can include EDR technology, offers an unconventional but effective solution to the ever-changing cybersecurity threat landscape. Challenges associated with implementing the present invention include defining and processing behavior, standardizing data and calculating event legitimacy scores.

According to one embodiment, the present invention is configured to collect security events from various sources and normalize them for uniformity, including, for example and without limitation, standardizing user names, paths, and other attributes. Preferably, the present invention is configured to exploit information stored in at least one log relative to an event so as to be able to process said event.

Preferably, computer events are pre-processed for clarity and relevance, stored in a secondary database that includes all the different known events. The present invention uses two structured databases, advantageously consisting of 36 tables for file, execution, process access, and network events.

Preferably, the primary database contains all the events common to several entities, and the secondary database contains all the events. Advantageously, an event moves from the secondary to the primary database when statistical criteria are validated, to ensure that the behavior is not specific to a perimeter.

According to one embodiment, the events are filtered to store only the most relevant ones in the primary, or main, database. According to one embodiment, said primary database is configured to be consulted using available tools, via an Application Programming Interface (API), for example.

According to one embodiment, dedicated tables, known as counting tables, count events on a daily, monthly and/or annual basis for each type of event. Advantageously, these tables allow for statistical monitoring of the occurrence of events. Preferably, specific tables, known as data tables, store detailed information on the files, users, paths and so on. Advantageously, with all the possible different values identified after normalization.

According to one embodiment, the present invention is configured to provide an on-demand analysis system, by processing requested computer events (by a customer or partner for example) in order to evaluate and score this behavior in relation to what is known in a database, for example.

Preferably, the score is defined based on the difference between a given computer event, advantageously based on an artificial intelligence model, and the closest computer event identified in the primary database.

According to one embodiment, after the preprocessing of a computer event, each text field is vectorized using a Large Language Model (LLM). For the other fields, such as ports or, more generally, any field that is a number, mathematical operations are used to represent them in vector form. Preferably, all the minimum vectors are combined into a single vector, which represents the computer event. Advantageously, these vectors are stored in a vector database. To assign a score, the vector most similar to the computer event is then searched in the database. Preferably, the score corresponds to the distance between the two vectors.

The present invention is advantageously designed to be efficiently and easily integrated into cybersecurity pipelines, for example via an API, facilitating interconnection with SIEMs, Security Orchestration, Automation, and Response (SOAR) and other tools. This integration allows Security Operations Center (SOC) teams to benefit from enriched analysis of the security events, helping to accurately distinguish legitimate activities from potential threats.

Furthermore, the present invention is preferably configured to contribute to developing security model rules, such as Zero-Trust, applied to operating systems; for example, by only allowing necessary, authenticated, and legitimate actions, thus reinforcing the security stance.

According to one embodiment, the use of an API of the present invention offers great flexibility, making it possible to integrate it into various environments and systems, which can greatly benefit proactive threat detection and incident response in the field of cybersecurity.

According to one embodiment, the present invention relates to a method for analyzing at least one computer event. Preferably, said method is configured to be implemented by at least one computer system.

Preferably, this method comprises several steps:
a. Receiving: a communication module receives at least one data event, said data event comprising a plurality of fields. Preferably, each field of said plurality of fields contains at least one data item.
b. Normalizing: A data processing module normalizes each data item of each field of said plurality of data of said computer event. The normalization is configured to homogenize the data for comparison data of computer events known as reference data. For example, the user name is replaced by “user”, common nouns are replaced by a predetermined label, and predetermined patterns can be identified and removed to make the data homogeneous.
c. Analyzing: An analysis module analyzes the normalized data with respect to reference data associated with reference computer events of a primary database. Preferably, the analysis step comprises for each normalized data item:
i. Identifying a reference computer event: For each value of said normalized data item, a search is performed for similar values in the primary database. If the reference computer event includes exactly the same fields with the same values, then the event is legitimate.
ii. Calculating a criticality score: If the reference computer event does not include exactly the same fields with the same values, a criticality score is calculated for each field whose values are different. The diversity between the values associated with this event and the values associated with the reference computer event is calculated and compared with a predetermined threshold value specific to each field to obtain a criticality score. Preferably, in the case of calculating a variance, the variance is calculated on the basis of all the reference events;
iii. Calculating a criticality score by summing the calculated criticality scores, preferably considering a weighting coefficient associated with each field of said plurality of fields. Preferably, the overall criticality score is obtained by summing the value, also known as the weight, of each field. The sum of the weights can be 100, for example, and advantageously, based on distance/difference/variance criteria, a score corresponding to the matching of each field is assigned.

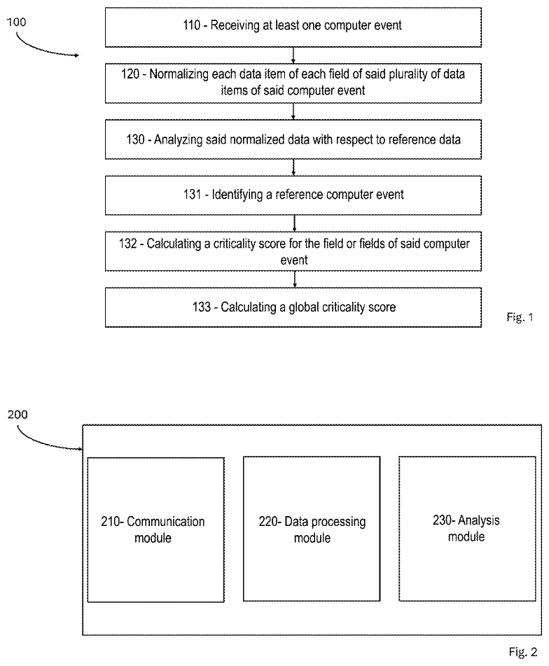

In more detail, as illustrated in FIGS. 1 and 2, the present invention relates to a method 100 for analyzing at least one computer event.

Preferably, said method 100 is configured to be implemented by at least one computer system 200.

According to one embodiment, said method 100 comprises at least the steps of:
a. Receiving 110, by at least one communication module 210, at least one computer event, said computer event preferably comprising a plurality of fields, each field of said plurality of fields advantageously comprising at least one data item;
b. Normalizing 120, by at least one data processing module 220, each data item of each field of said plurality of data items of said computer event;
c. Analyzing 130, by at least one analysis module 230, said normalized data with respect to reference data associated with reference computer events of a primary database.

According to one embodiment, the analysis step 130 comprises, for each normalized data item, the following steps:
a. Identifying 131 at least one reference computer event, this identification step comprising:
i. For each value of said normalized data item, a search for similar values in the primary database;
b. If the reference computer event comprises, preferably exactly, the same fields with the same values, then the event is legitimate;
c. If the reference computer event does not comprise, preferably exactly, the same fields with the same values, then:
i. Calculating 132 a criticality score, with respect to said identified reference computer event, for the field or fields of said plurality of fields of said computer event whose values are different:
A) Calculating the diversity between the values associated with said computer event and the values associated with said reference computer event; and
B) Comparing this diversity with a first predetermined threshold value specific to each field so as to obtain a criticality score;
ii. An overall criticality score of said computer event is calculated 133 by summing the calculated criticality scores, preferably by considering at least one weighting coefficient associated with each field under consideration;
iii. Said overall criticality score is configured for use in decision-making by at least one operator or by at least one automatic system.

Advantageously, the present invention allows for an improved detection of threats. In fact, by normalizing and analyzing data with respect to reference events, the present invention makes it possible to more effectively distinguish normal activities from potentially malicious actions. In addition, calculating a criticality score based on the diversity of values allows for a precise assessment of the severity of computer events, thus facilitating decision-making by the operator.

Advantageously, the present invention can be implemented by various computer systems and is configured to accommodate heterogeneous data from multiple sources, making it versatile in different cybersecurity contexts. Furthermore, by using reference data and calculating criticality scores, the present invention allows the number of false positives to be reduced, thus improving the efficacy of security systems.

Finally, preferably, the overall criticality score obtained allows the operator to make informed and quick decisions, which is useful in managing security incidents.

According to one embodiment, the computer event in question comprises at least two distinct parts:
a. A part initiating at least one action, that is, the indication of a computer program performing the action. This part is characterized by the fact that it manages at least one action and does so through a program that executes this action.
b. An action part, that is, the action performed by said program on a target. This is characterized by the action performed by the program, as well as by the target of this action.

According to one embodiment, the step of searching for similar values comprises searching for a maximum of matching fields between the computer event and a reference computer event.

According to one embodiment, this search step involves an in-depth comparison of the characteristics of the two computer events in question. Advantageously, this search step can include the use of advanced search algorithms to facilitate the comparison and classification of the data.

According to one embodiment, calculating the diversity of values involves calculating a variance. This characteristic means that analyzing the diversity of values involves statistically calculating the dispersion of data around an average. Preferably, this approach makes it possible to measure and compare variability between different data sets. According to one embodiment, the variance represents a measure of the dispersion of the values around an average and can be used to determine whether the data is dispersed or concentrated around this average.

According to one embodiment, analysis of the diversity of values can be used to identify significant differences between different data sets.

According to one embodiment, the predetermined threshold value is a measure of statistical dispersion that represents the standard deviation of data in a population or data set. Preferably, this threshold value is predefined and fixed. It is used to identify significant differences between two sets of data, for example.

Advantageously, this threshold value can be used to identify significant differences between two variables. It can also be used to identify significant differences between two groups of data.

According to one embodiment, the present invention comprises a step for making a decision based on said overall criticality score. Preferably, this decision-making stage is integrated into a larger system that allows automatic decisions to be made based on the overall criticality score calculated. It is worth noting that the accuracy of the overall criticality score can have a significant impact on the quality of the decisions made. Consequently, it is preferable to use a reliable and accurate method of calculating the overall criticality score, as proposed in the present invention.

Finally, it is also worth noting that the overall criticality score can be used to make decisions at different levels of hierarchy within a system. For example, an overall criticality score can be calculated at a higher level to guide decisions taken at a lower level.

According to one embodiment, the present invention comprises an analysis step based on the overall criticality score. Preferably, this analysis step allows the overall criticality score obtained to be processed using appropriate methods to determine the consequences or actions to be taken based on the result obtained. In this way, the analysis step can help to make informed and effective decisions based on the severity or significance of an event, situation or result.

According to one embodiment, the present invention can comprise calculating a criticality pre-score. Preferably, the present invention includes a step of vectorizing the reference computer events to generate a plurality of reference vectors. Advantageously, this vectorization step is carried out using a specific algorithm that transforms the digital data of the reference computer events into vectors in such a way as to preserve their structure and significance.

According to one embodiment, the present invention also comprises a step of vectorizing the computer event to generate an event vector. Preferably, this vectorization step is carried out using the same algorithm as that used for vectorizing the reference computer events.

According to one embodiment, the present invention may then comprise a step of calculating a distance between the event vector and each reference vector of said plurality of reference vectors.

Preferably, this calculation step uses a specific algorithm to measure the difference between the vectors according to their numerical composition.

According to one embodiment, the present invention then comprises a step for selecting the smallest of the calculated distances.

Preferably, this selection step is performed using a specific algorithm that determines the minimum distance between the event vector and a plurality of reference vectors, advantageously the minimum distance between the event vector and each reference vector.

According to one embodiment, the selected distance corresponds to said criticality pre-score. Preferably, this distance can also be used to assess the criticality of the computer event in question.

According to one embodiment, diversity is calculated by vectorization. This method allows data to be represented as vectors in a vector space, facilitating their analysis and comparison. Preferably, each element to be analyzed is converted into a digital representation (vectorization) so that it can be processed by diversity calculation algorithms. This technique presents several benefits:
a. It allows the data to be represented in a vector space, which facilitates their analysis and comparison.
b. It allows complex data (images, text, etc.) to be processed by converting them into vectors, which simplifies their processing by algorithms.
c. It allows the diversity between different elements to be calculated using specific algorithms such as Euclidean distance or cosine similarity.

In addition, this technique can be combined with other techniques such as machine learning to improve the results of diversity calculations.

According to one embodiment, the present invention comprises a step of building a primary database of reference computer events. Preferably, this step comprises:
a. Receiving a plurality of computer events. The events received are processed by the data processing module.
b. If all the fields of the different events contain identical values, the data processing module performs a deduplication of each event of the plurality of computer events. This means that if all fields have identical values for the same event, the same computer event is only recorded once in the primary database.
c. Event of the number of times the event has occurred, that is, adding a unit to a counter, by at least one event module. This allows the frequency of each event to be determined, that is, the number of times an event occurs.
d. Normalizing each data item of each computer event by said data processing module. This means that data from different events is processed to make it uniform and mutually compatible.
e. For each event, a search is performed in the primary database to ascertain whether the computer event already exists. If the event already exists, the frequency information is modified to add the fact that it has occurred again. Otherwise, a search is performed in a secondary database. If the event already exists in the secondary database, the frequency information is modified to add the fact that it has occurred again.
f. The frequency data are examined to determine whether the event can be moved to the primary database. This is done by comparing the frequency of the event with a predetermined frequency threshold and/or the number of entities that have reported this event. Note that an entity can be a computer system, or even a specific application of a computer system. If the frequency data indicates that the event can be moved to the primary database because its occurrence exceeds the threshold, it is added to the primary database.
g. Should the event not exist in the secondary database, it is added to the secondary database.

This step allows the primary and secondary databases to be built up continuously, adding a dynamic dimension to the present invention and enabling it to be enriched over time.

According to one embodiment, the present invention includes a feature for adapting to at least one local context of a specific perimeter. This feature allows the primary database to be refined so as to reduce false positives linked to programs or behavior that are specific to a given perimeter but legitimate in that context.

The primary database can be configured to be fed, advantageously on an ongoing basis, with preferably anonymized data collected from customer perimeters. This feed, which is advantageously continuous, ensures that the primary database is as complete as possible, thus providing relevant criticality scores for all the common events and programs encountered in different environments.

According to one embodiment, a program specific to a given perimeter can trigger a false positive if it is not known to the primary database. To avoid this situation, the present invention can comprise a learning phase, preferably local, configured to enrich the primary database with computer events specific to the perimeter under consideration.

According to one embodiment, the local learning phase comprises the following steps:
a. Collecting computer events on the local perimeter without assigning a criticality score, these events being intended for learning rather than immediate analysis;
b. Applying the same building policy as used for the primary and secondary databases, but using an initially blank local secondary database;
c. Gradually enriching the primary database with validated computer events from the local perimeter that meet predetermined criteria of frequency and/or legitimacy.

Preferably, this local learning phase allows the primary database to be adapted to the specific context of a perimeter, while maintaining the global consistency of the analysis system.

According to one embodiment, the present invention comprises a validation step by at least one operator, for example a human operator, of the modifications made to the primary database during the local learning phase. Preferably, this step involves generating a differential report between the original primary database and the primary database updated after local learning.

Advantageously, this differential report allows an operator to view specific computer events that have been added to the primary database. This visualization allows validation that the elements added actually correspond to legitimate behavior specific to the perimeter and not to malicious sources.

Preferably, this validation ensures that the specific computer events added do not distort future criticality scores calculated for other computer events. Indeed, adding malicious events to the primary database could lead to behavior that is actually malicious being considered legitimate, thus compromising the efficacy of the analysis system.

According to one embodiment, the differential report comprises at least:
a. A list of the computer events added to the primary database;
b. For each event added, the associated frequency information;
c. Preferably, an indication of the original perimeter of each added event;
d. Advantageously, a validation interface allowing the operator to approve or reject each proposed addition.

According to one method, only computer events validated by the operator are definitively integrated into the primary, or global, database. The rejected events can be stored in a local, perimeter-specific database or deleted according to a predetermined management policy.

Advantageously, the local learning feature according to the present invention allows the rate of false positives to be significantly reduced in specific environments while maintaining a high level of security. Indeed, this approach takes into account the particularities of each perimeter without compromising the detection of real threats.

In addition, the validation of additions to the primary database by an operator ensures quality control, preventing the introduction of malicious events that could be used to bypass the detection system. This combination of automatic learning and validation offers an optimum balance between automation and security.

Finally, the continuous feeding of the primary database from multiple customer perimeters enables the relevance of the criticality scores to be constantly improved, with the present invention benefiting from the collective experience of all the users while respecting the anonymization of the data.

According to one embodiment, the present invention includes a step for generating a report for each computer event.

Preferably, said report comprises the computer event with its fields, data and values.

Preferably, the report includes the overall criticality score associated with the computer event, or even advantageously at least one criticality score associated with at least one field.

Advantageously, the report can include a predetermined number, for example 20, of reference computer events which have an overall criticality score below the second threshold and which are closest, in terms of similarity or number of closest fields, to said computer event in question.

According to one embodiment, the operator can be a human user or a machine, thus extending the flexibility and adaptability of the proposed solution to various contexts.

According to one embodiment, the operator is a machine: This means that the system can be automated, enabling repetitive, monotonous tasks to be performed without human assistance.

Preferably, the operator can comprise a decision-making unit configured to make autonomous decisions based on the data it receives, thereby improving the performance and reliability of the system.

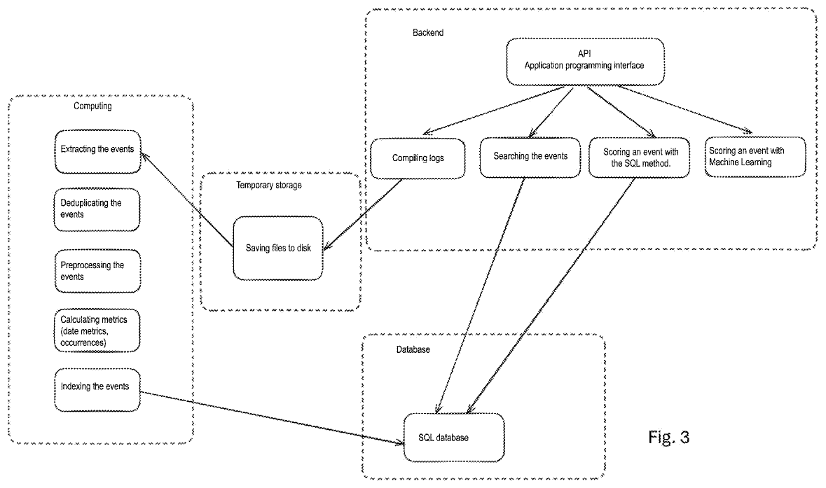

According to one embodiment, FIG. 3 depicts a diagram representing at least one part of the method according to the present invention.

In FIG. 3, this diagram depicts a data processing pipeline and backend infrastructure designed for the extraction, pre-processing and analysis of computer events.

According to FIG. 3, the present invention comprises a calculation layer. This calculation layer comprises:
a. Extracting the Events:
i. The raw data are processed to extract significant events.
ii. This step involves parsing the data to identify relevant entities or actions.
b. Deduplicating:
i. Eliminates duplicates to ensure unique data entries.
ii. It may include algorithms to compare event identifiers or metadata.
c. Preprocessing—Normalizing:
i. Cleans, transforms or normalizes events to prepare them for further analysis.
ii. It may comprise normalizing formats, filling in missing values or other data cleansing techniques.
d. Calculating Metrics:
i. Generates metrics from the events, such as:
A) Counts (e.g. frequency of events)
B) Metrics based on dates (e.g. chronologies or event durations)
e. Indexing Events in a database, for example an SQL (Structured Query Language) type database:
i. The events are indexed to facilitate search and quick retrieval.
ii. A structured format, such as JSON or an inverted index, can be used for quick queries.
f. CSV file per Entity:
i. The events processed and indexed are stored in files, such as CSV files for example.
ii. Each file represents a specific entity or category.
iii. Preferably, each CSV file comprises the computer events of one computer, which belongs to one entity.
g. Storage:
i. The intermediate data, including extracted or pre-processed events, are saved in storage for rapid access and back-ups.
Still in accordance with FIG. 3, the present invention comprises backend layer. This backend layer comprises:
a. An API:
i. A RESTful API framework, for example, can act as the backbone of the backend system, enabling interaction between users and the database.
ii. Main features of the API:
A) Compiling logs, for example CSV files:
   Aggregates incoming logs or raw data for processing.
B) Event searching, preferably in the primary database:
   Allows users to query and retrieve specific events or information.
C) Analyzing the Events (Score):
   Applies scoring or ranking mechanisms to evaluate events according to predefined metrics.
b. Database:
i. Serves as a persistent storage layer.
ii. Stores the processed and indexed events, metrics and other relevant data.
iii. Allows efficient queries and data retrieval.
c. Saving Files to Disk:
i. The raw logs or intermediate processing results are stored on disk to ensure their durability and traceability.
ii. Serves as backup or audit log.

According to FIG. 3, the data flow can be as follows:
a. The pipeline starts with raw data, that is, the CSV files, processed sequentially via the extracting, deduplicating and preprocessing/normalizing steps.
b. The metrics are calculated and indexed before being stored in CSV files or in the database.
c. The backend API facilitates access to this data for further analysis or visualization.
d. The storage, potentially temporary, ensures that the intermediate results are not lost, providing reliability and flexibility in the workflow.

This figure depicts a diagram that effectively combines calculation-intensive processing with a scalable backend to manage the analysis and consultation of events in real time.

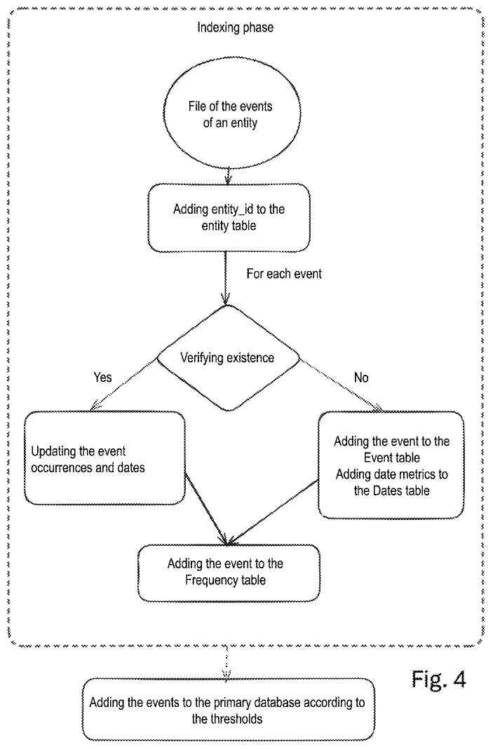

According to one embodiment, FIG. 4 depicts a diagram representing an event indexing embodiment according to the present invention.

In FIG. 4, and according to one embodiment, a diagram shows the steps involved in indexing a computer event, more specifically the steps involved in building the primary database.

Thus, according to FIG. 4, this diagram comprises:
a. A step for acquiring one or more CSV files, each file of which may comprise at least one computer event: The present invention thus comprises importing CSV files containing data linked to one or more computer events.
b. Adding the computer event or events to one or more event tables: The present invention comprises extracting the identification of each computer event from the CSV file or files, and then associating these identifications with a dedicated “Entity table”. Preferably, each event is broken down into one or more tables and linked to a dedicated “entity” table;
c. Processing the events:
i. Each event is verified to check whether it already exists in a secondary database:
A) Yes: If the event exists, the present invention updates the number of occurrences (“count”) as well as the dates associated with this event.
B) No: If the event does not exist, it is added to the secondary database with its corresponding dates.
d. Adding events to a frequency table: Once the verification and addition stage is complete, the events can be added to a frequency table called “Freq table”.
e. Adding to the primary database according to defined thresholds: The events are then transferred to the primary database, respecting predefined thresholds or criteria, as previously described.

FIG. 4 illustrates a structured process for integrating, verifying, updating and managing the data of computer events from CSV files in databases, while respecting processing rules and thresholds.

In order to illustrate the present invention, examples will now be described in a non-limiting manner.

Here is an example of field matching and notation:
According to one embodiment, the present invention is configured to evaluate different fields, such as, for example: source_process_filename_id, target_process_filename_id, source_process_extension_id, etc.

For each field, the present invention preferably checks whether the field value corresponds to a specific target value. If a match is found, advantageously a predefined score is added to the global similarity score of this event. If no match is found, a score of 0 is added. The total similarity score for each event is preferably the sum of the individual scores for the matching fields. Advantageously, this total score, also known as the overall criticality score of the event, can then be rounded to two decimal places using the ROUND function.

According to one example, the “users” field consists of a domain or computer name followed by a backslash “\”, then a user name or account name. The present invention can be configured to extract the user name or account name. If it is a common generic user such as “NT SYSTEM”, “NETWORK”, “SYSTEM”, “IIS_USRS”, “ADMINISTRATOR”, “SERVICE”, “LOCAL SERVICE”, “NETWORK SERVICE”, “GUEST”, “ANONYMOUS”, “SA”, “ROOT”, “WWW-DATA”, “NOBODY”, “FTP”, for example. Preferably, this name is kept as it is. In another embodiment, this name can be normalized. Then, preferably, the present invention is configured to check this name to distinguish whether it is a local user or a domain user, for example.

Here are some examples:
a. Dupont\MON_ENTREPRISE⇒Domain User
b. Système\AUTORITE NT⇒NTSystem
c. nucleon-pc\DESKTOP-BOMV2OM⇒Local User
d. SERVICE RéSEAU\AUTORITE NT⇒Network Service

With regard to the domain, the present invention can be configured to separate the domain into two parts: a top domain and a sub-domain.

Here are some examples:
a. example.nucleon-security.com⇒top domain: nucleon-security.com, ⇒sub-domain: example
b. Eu-teams.events.data.microsoft.com⇒top domain: microsoft.com, ⇒sub-domain: eu-teams.events.data

With regard to Internet Protocol IP addresses, the present invention can be configured to detect the type and version of the IP address using, for example, a well-known python library.

Here is an example:
a. 142.250.179.72⇒version: Ipv4⇒type: public IP

With regard to the path, the present invention can be configured to first extract the device, then the file name, the file extension and the data_path information.

Here are some examples:
a. For a device:
i. The present invention can include a step to check whether the path begins with “\\”, indicating a network share, for example.
ii. Next, the present invention can check for the presence of a colon “:” in the path, which usually indicates a local drive or a removable drive, if the drive is C or D, it is possible to assume that it is a local drive, otherwise it is possible to assume that it is not a local drive.
b. For a file:
i. The present invention can be configured to extract the file name and check whether it is included in a list of known system files.
ii. If it is a known system file, the file can keep the name.
iii. If it is a random name, the present invention is configured to rename it.
iv. The present invention can also be configured to extract the file extension.
v. The present invention can also be configured to extract the component list of the path, and/or the folders and sub-folders of the access path, for example.

We will now examine some examples of the steps involved in normalizing a computerized event.

Example of an event to analyze:
a. {“type”: “read”, “timestamp”: “2024-09-05T11:10:55.948Z”, “user”: “DESKTOP-NJC0C1D\\hp”, “process_path”: “C:\\ProgramFiles\\WindowsApps\\Microsoft.WindowsTerminal_1.20.11781.0_x64_8wekyb3d8bbwellelevate-shim.exe”, “file_path”: “C:\\Windows\\System32\\ntdll.dll”, “event_type”: “read”}

According to one embodiment, the present invention can comprise a preprocessing phase. Preferably, this preprocessing can comprise several steps.

This pre-processing can start with a step of normalizing strings of characters to replace values or elements of specific values. For example, IP addresses can be replaced by {ipv4} or {ipv6} labels, depending on their version. The numbers in the “command” field of execution events can be replaced by {integer}.

The present invention is preferably configured to also identify random character strings using Natural Language Processing (NLP)-type methods, allowing these strings of characters to be replaced by {RANDOM}, and versions to be replaced by {VERSION}, for example.

In addition, the present invention can apply a similar approach for the user name that may be present in a path, it will be replaced by {USER}, for example, unless it is a known name, such as: NTSystem.

In the above case, the following path:
a. C:\\ProgramFiles\\WindowsApps\\Microsoft.WindowsTerminal_1.20.11781.0_x64_8wekyb3d8bbwe\\elevate-shim.exe Becomes as follows after normalization:
b. Microsoft.WindowsTerminal_1.20.11781.0_x64_8wekyb3d8bbwe=>microsoft.windowsterminal_{VERSION}_x64_{RANDOM}

After preprocessing the event, the present invention is configured to decompose the event into a predetermined format, such as json, for example, with fields specific to each type of event.

For example, the “user” Field: DESKTOP-NJC0C1D\\hp⇒{user}

For example, common fields for all event types=>the source program that performs the action:
a. Source_process_filename
b. Source_process_extension
c. Source_process_path
d. Source_process_device
e. source_process_(md5/sha1/sha256)
f. source_process_signature

For the “File” event (file access: read/write/rename/delete)
a. target_file_filename
b. target_file_extension
c. target_file_path
d. target_file_device
e. target_file_(md5/sha1/sha256)
f. target_file_signature

For the “Execute” event (program execution)
a. target_process_filename
b. target_process_extension
c. target_process_path
d. target_process_device
e. target_process_(md5/sha1/sha256)
f. target_process_signature
g. command

For the “Open process” event (access to the memory of one program by another)
a. target_process_filename
b. target_process_extension
c. target_process_path
d. target_process_device
e. target_process_(md5/sha1/sha256)
f. target_process_signature

For the “Network” event (establishment of a network connection by a program)
a. Port
b. Protocol
c. Ip (ip address version, IP address type)
d. Domain (top domain, sub-domain)

Example of event in JSON after pre-processing:
a. {‘user’: USER,
b. ‘source_process_md5’: None,
c. ‘source_process_sha1’: None,
d. ‘source_process_sha256’: None,
e. ‘source_process_path’: ‘\\program
f. files\\windowsapps\\microsoft.windowsterminal_{version}_x64_{random},
g. ‘source_process_device’: {‘device_letter’: “C”, ‘device_type’: Local},
h. ‘source_process_filename’: elevate-shim,
i. ‘source_process_extension’: exe,
j. ‘source_process_signature’: None,
k. ‘target_file_md5’: None,
l. ‘target_file_sha1’: None,
m. ‘target_file_sha256’: None,
n. ‘target_file_path’: \\windows\\system32’,
o. ‘target_file_device’: {‘device_letter’: “C”, ‘device_type’: Local},
p. ‘target_file_filename’: ntdll,
q. ‘target_file_extension’:dll,
r. ‘target_file_signature’: None,
s. ‘event_type’: read

We will now examine some examples of how to assign a score.

According to one embodiment, each field of the plurality of fields comprises a weighting, that is, a predefined weighting value, such as a weighting coefficient, otherwise called a predefined weight, for example:
a. Common weights (used in several events):
i. user: 1
ii. source_process_md5: 1
iii. source_process_sha1: 1
iv. source_process_sha 256: 1
v. source_process_signature: 2
vi. source_process_path: 2 (for “read”, “rename”, “write”, “delete” and “open_process”)
vii. source_process_device: 1.25 (for “read”, “rename”, “write”, “delete” and “open_process”)
viii. target_process_md5: 1 (for “execute” and “open_process”)
ix. target_process_sha1: 1 (for “execute” and “open_process”)
x. target_process_sha256: 1 (for “execute” and “open_process”)
xi. target_process_signature: 2 (for “execute” and “open_process”)
b. “read”, “rename”, “write”, “delete” events:
i. source_process_filename: 7
ii. source_process_extension: 1.5
iii. target_file_md5: 1
iv. target_file_sha1: 1
v. target_file_sha256: 1
vi. target_file_filename: 8
vii. target_file_extension: 1.5
viii. target_file_path: 2
ix. target_file_device: 1.25
x. target_file_signature: 2
c. “Execute” event:
i. source_process_filename: 6
ii. source_process_extension: 3
iii. source_process_path: 4
iv. source_process_device: 2
v. target_process_filename: 7
vi. target_process_extension: 3
vii. target_process_path: 4
viii. target_process_device: 2
ix. command: 10
d. “Open_process” event:
i. source_process_filename: 8
ii. source_process_extension: 1.5
iii. target_process_filename: 9
iv. target_process_extension: 1.5
v. target_process_path: 2
vi. target_process_device: 1.25
e. “Network” event:
i. source_process_filename: 5
ii. source_process_extension: 3
iii. source_process_path: 4
iv. source_process_device: 2
v. port: 7
vi. protocol: 7
vii. domain: 8
viii. ip: 6

According to one embodiment, the weighting coefficient of each field of said plurality of fields is taken into account in calculating the sum of the criticality scores calculated, said sum corresponding to said overall criticality score.

According to one embodiment, the step of calculating an overall criticality score may comprise at least two steps:
a. Determining variances: If the relationship between two fields has a high variance, that is, exceeds a predetermined threshold value (for example, a source process accesses many target files or processes), the weight of the field in question can be removed, as all values of the target field are possible.
i. To this end, the present invention may include a variance table; this table contains the unique number of each field with respect to another, and if the number exceeds a predefined threshold, then it is considered to have a very high variance. For example, if the chrome. exe process accesses close to 3,000 IP addresses, the weight of the IP field is removed.
ii. After eliminating all fields that have a large variance, the present invention can be configured to disregard fields that are not present in the event under consideration.
iii. Then, the present invention can be configured to normalize the weighting coefficients of the remaining fields so that their sums equal 100%. Here is the result for the previous example: {‘source_process_filename’: 29.166666666666668, ‘target_file_filename’: 33.33333333333333, ‘source_process_extension’: 6.25, ‘target_file_extension’: 6.25, ‘source_process_path’: 8.333333333333332, ‘target_file_path’: 8.333333333333332, ‘event_type’: 4.166666666666666, ‘user’: 4.166666666666666};
b. Next, the present invention comprises searching the primary database for similar events: To this end, the present invention can be configured to generate an SQL query that calculates, for each event in the primary database, its similarity using the weighting coefficients associated with the various fields, and then the highest scores are considered. Here is an example query: SELECT id, ROUND((CASE WHEN “source_process_filename_id”=5107981 THEN 29.166666666666668 ELSE 0 END+CASE WHEN “target_file_filename_id”=11937 THEN 33.33333333333333 ELSE 0 END+CASE WHEN “source_process_extension_id”=1 THEN 6.25 ELSE 0 END+CASE WHEN “target_file_extension_id”=25 THEN 6.25 ELSE 0 END+CASE WHEN “source_process_path_id”=85 THEN 8.333333333333332 ELSE 0 END+CASE WHEN “target_file_path_id”=7 THEN 8.333333333333332 ELSE 0 END+CASE WHEN “event_type_id”=3 THEN 4.166666666666666 ELSE 0 END+CASE WHEN “user_id”=1 THEN 4.166666666666666 ELSE 0 END), 2) AS similarity_score FROM “File_event” ORDER BY similarity_score DESC LIMIT 1; According to one embodiment, the similarity between a computing event and a reference computing event takes into account the weighting coefficients of the fields under consideration. Preferably, the query is configured to scan all the rows of the event table and check whether each field exists. If this is the case, a weighting coefficient is added. The result is a score for each row that reflects the row's similarity to the event under consideration, that is, a criticality score for each field of the event under consideration.

Advantageously, through the extraction of the fields and their normalization, the present invention makes it possible to build a primary database, known as a reference database, and to detect suspicious or “abnormal” behavior.

According to one embodiment, the present invention likewise relates to a computer system 200 for analyzing at least one computer event. This system 200 advantageously comprises several distinct modules that work together to analyze data from the computer events and identify abnormal behavior.

The first module is communication module 210, configured to receive at least one computer event. Each computer event comprises a plurality of fields, each field comprising at least one data item. The communication module collects this data and transmits it to the data processing module.

The second module is data processing module 220, configured to normalize each data of each field of said plurality of fields of said computer event. This normalizing step consists of replacing specific values or elements of values with standardized values, such as IP addresses with the labels {ipv4} or {ipv6} depending on their version, as described above

The third module is the analysis module 230, configured to analyze the normalized data against reference data associated with reference computer events in a primary database. This analysis step consists of identifying at least one reference computer event, calculating a criticality score for the fields whose values are different, and calculating the diversity between the values associated with this event and the values associated with the reference event, preferably by considering the weighting coefficients of the fields considered.

Advantageously, the first analysis step is configured to identify a reference computer event in the primary database.

The second analysis step is configured to calculate a criticality score for each field whose values are different. This score is defined according to the difference between the value of this event and the value of the reference event identified in the primary database.

The third analysis step is configured to calculate the diversity between the values associated with this event and the values associated with the reference event. This diversity is defined based on the unique number of each field in relation to another, such as the unique number of target processes in relation to a source process. According to one example, if a number exceeds a predefined threshold, this diversity is considered very high and this field is removed from the analysis.

The fourth, and potentially last, analysis step can be configured to compare the calculated diversity with a predetermined threshold value specific to each field to obtain a criticality score for each field under consideration. An overall criticality score is then calculated based on the criticality scores for each field. If the overall criticality score is greater than the predefined threshold, the computer event is considered abnormal and a security alert is generated.

As illustrated in FIG. 2, the computer system 200 according to one embodiment of the present invention comprises several separate modules 210, 220, 230 that work together to analyze the data from computer events and identify abnormal behavior. The communication module 210 collects data from computer events, the data processing module 220 normalizes this data and the analysis module 230 compares this data with known data to identify abnormal behavior. The results of this analysis are used to generate security alerts in case abnormal behavior is detected.

More specifically, and according to one embodiment, the present invention relates to a computer system for analyzing at least one computer event.

Preferably, said system 200 comprises at least:
i. A communication module 210 configured to receive 110 at least one computer event, said computer event comprising a plurality of fields, each field of said plurality of fields comprising at least one data item;
ii. A data processing module 220 configure to normalize 120 each data item of each field of said plurality of fields of said computer event;
b. An analysis module 230 configured for:
i. Analyzing 130 said normalized data with respect to reference data associated with reference computer events in a primary database;
ii. Identifying 131 at least one reference computer event, this identification step comprising;
iii. Calculating 132 a criticality score, with respect to said identified reference computer event, for the field or fields of said plurality of fields of said computer event whose values are different;
iv. Calculating the diversity between the values associated with said computer event and the values associated with said reference computer event;
v. Comparing this diversity with a first predetermined threshold value specific to each field so as to obtain a criticality score;
vi. Calculating the sum of the calculated criticality scores so as to calculate 133 an overall criticality score

According to one embodiment, the computer system 200 comprises a central server and several workstations.

According to one embodiment, each workstation is connected to the central server via a network connection.

According to one embodiment, computer system 200 is equipped with an advanced security system to protect the sensitive data and information of the users.

According to one embodiment, the computer system 200 is designed to be scalable and to handle a large number of users simultaneously.

According to one embodiment, the computer system 200 is equipped with an automatic data backup system to guarantee the security of the data of users.

According to one embodiment, the computer system 200 is designed to be compatible with different types of peripherals and software.

According to one embodiment, the computer system 200 is equipped with an automatic update management system to guarantee the security and performance of the system.

According to one embodiment, the computer system 200 depicted in FIG. 2 can be equipped with a processor configured for processing data, performing calculations and executing operations. Preferably, it is also equipped with an intuitive user interface to facilitate use by non-experienced users.

According to one embodiment, the computer system 200 can be connected to a communications network to allow the transmission and exchange of data with other similar systems. Advantageously, it is also equipped with an advanced security system to protect sensitive data from intrusions and malicious attacks, said security system being configured to cooperate with the present invention.

According to one embodiment, the computer system 200 can be equipped with high-capacity data storage to allow important data to be backed up and archived. Furthermore, a backup system can be added to ensure data security in the event of system failure.

According to one advantageous embodiment, the computer system 200 is equipped with an intuitive, ergonomic graphical interface to facilitate navigation by users.

The present invention provides an on-demand security event analysis system that uses an advanced normalizing and contextualizing methodology to transform heterogeneous data from multiple sources into a unified format. This approach allows consistent, comparative analysis of security events, which are evaluated by a system based on risk scores. One of the aims of the present invention is to identify any deviations from known normal behavior, which could indicate a potential threat. This invention is particularly relevant in the cybersecurity landscape, where threats are diverse and constantly evolving. It operates according to the Zero Trust philosophy, which focuses on listing known elements and creating rules to authorize them. EDR technology can be used to collect data from endpoints and create a database of known events.

The invention is not limited to the embodiments disclosed previously and extends to all the embodiments covered by the claims.

1. A method for analyzing at least one computer event, said method being configured to be implemented by at least one computer system, said method comprising at least the following steps:
a. Receiving, by at least one communication module, at least one computer event, said computer event comprising a plurality of fields, each field of said plurality of fields comprising at least one data item;
b. Normalizing, by at least one data processing module, each data item of each field of said plurality of data items of said computer event;
c. Analyzing, by at least one analysis module, said normalized data with respect to reference data associated with reference computer events of a primary database, the analysis step comprising for each normalized item of data:
i. Identifying at least one reference computer event, this identification step comprising:
For each value of said normalized data item, searching for at least one reference event comprising at least one similar value in the primary database, said search comprising searching for a maximum of matching fields between the computer event and a reference computer event so as to identify a unique most similar reference computer event;
ii. If the reference computer event comprises, preferably exactly, the same fields with the same values, then the event is legitimate;
iii. If the reference computer event does not comprise, preferably exactly, the same fields with the same values, then:
Calculating a criticality score, with respect to said identified reference computer event, for the field or fields of said plurality of fields of said computer event whose values are different:
A. Calculating, for each field having different values, the diversity between the values of said field associated with said computer event and the values of said same field associated with said reference computer event; and
B. Comparing this diversity calculated for each field with a first predetermined threshold value specific to each field so as to obtain a criticality score for each field;
Calculating an overall criticality score for said computer event by summing together the calculated criticality scores for each field;
Said overall criticality score is configured for use in decision-making by at least one operator.

2. The method according to claim 1, wherein the computer event comprises at least two components: a component initiating at least one action, and an action component configured to perform at least one action.

3. The method according to claim 1, wherein calculating the diversity of the values comprises calculating a variance, said variance being calculated based on all the reference events in the primary database for the field under consideration.

4. The method according to claim 1, wherein the predetermined threshold value is a variance.

5. The method according to claim 1, further comprising a decision-making step based on at least one criticality score and/or said overall criticality score.

6. The method according to claim 1, further comprising an analysis step based on at least one criticality score and/or said overall criticality score.

7. The method according to claim 1, further comprising a step of calculating a criticality pre-score comprising:
a. Vectorizing reference computer events so as to generate a plurality of reference vectors;
b. Vectorizing the computer event so as to generate an event vector;
c. Calculating a distance between the event vector and each reference vector of said plurality of reference vectors;
d. Selecting the smallest of the calculated distances, this selected distance corresponding to said criticality pre-score.

8. The method according to claim 7, wherein the diversity calculation is performed by vectorization.

9. The method according to claim 1, further comprising at least one step of building said primary database of reference computer events, the building step comprising at least:
a. Receiving a plurality of computer events comprising a set of fields;
b. If all the fields contain identical values:
i. Deduplicating, by said data processing module, each event of said plurality of computer events;
ii. Evaluating, by at least one event module, the number of times the event has occurred;
c. Normalizing, by said data processing module, each data item of each computer event of said plurality of computer events;
d. For each event of said plurality of computing events:
i. Searching in said primary database if the computer event exists:
If the computer event exists in said primary database: modifying the frequency information of said computer event to add a new occurrence of said computer event, said frequency information comprising at least an entity number having reported said computer event, an occurrence number of said computer event;
Otherwise: Searching a secondary database:
1. If the computer event exists in said secondary database:
A. Modifying the frequency information of the computer event;
B. If at least one of the modified frequency information values is above a predetermined threshold, moving said computer event to the primary database;
2. Otherwise, adding the event to the secondary database.

10. The method according to claim 9, further comprising a local learning phase for adapting the primary database to a specific perimeter, said phase comprising:
a. Collecting local computer events on said specific perimeter;
b. Enriching the primary database with said local computer events satisfying at least one predetermined frequency criterion; and
c. Validating the added computer events before their final integration into the primary database.

11. The method according to claim 1, further comprising at least one step of generating a report for each computer event comprising:
a. Said computer event with its fields, data, and values;
b. Said overall criticality score;
c. The reference computer events whose overall criticality score is below a second threshold value.

12. The method according to claim 1, wherein the operator is a human user or a machine, preferably comprising a decision-making unit.

13. A computer program product comprising a plurality of instructions which, when they are executed by at least one processor, execute the method according to claim 1.

14. A non-transitory memory medium comprising a computer program product according to claim 13.

15. A computer system for analyzing at least one computer event, said system comprising at least:
a. A communication module configured for:
i. Receiving at least one computer event, said computer event comprising a plurality of fields, each field of said plurality of fields comprising at least one data item;
b. A data processing module configured for:
i. Normalizing each data item of each field of said plurality of fields of said computer event;
c. An analysis module configured for:
i. Analyzing said normalized data with respect to reference data associated with reference computer events in a primary database;
ii. Identifying at least one reference computer event;
iii. Calculating a criticality score, with respect to said identified reference computer event, for the field or fields of said plurality of fields of said computer event whose values are different;
iv. Calculating the diversity between the values associated with said computer event and the values associated with said reference computer event;
v. Comparing this diversity with a first predetermined threshold value specific to each field so as to obtain a criticality score;
vi. Calculating the sum of the calculated criticality scores so as to calculate an overall criticality score.
